(19) United States
(12) Patent Application Publication
(10) Pub. No.: US 2026/0092904 A1
(43) Pub. Date: Apr. 2, 2026

(54) GAS CHROMATOGRAPH WITH DYNAMIC RESPONSE FACTORS

(71) Applicant: Rosemount Inc., Shakopee, MN (US)

(72) Inventors: Edward Xiaoyan Zhang, Cypress, TX (US); Stephen Ray Samares, Montomergy, TX (US); Wanjun Yu, Sugar Land, TX (US)

(21) Appl. No.: 18/901,639

(22) Filed: Sep. 30, 2024

(51) Int. Cl. G01N 30/20; G01N 30/02; G01N 30/68; G01N 30/70; G01N 30/74

(52) U.S. Cl. CPC G01N 30/20; G01N 30/68; G01N 30/70; G01N 30/74; G01N 2030/025; G01N 2030/201

(57) ABSTRACT

A gas chromatograph for analyzing content of a gas sample includes a sample gas inlet configured to receive the gas sample and a carrier gas source which provides a carrier gas. A separation column is configured such that individual component gases in the sample gas separate as they move through the separation column. A first sample valve is coupled to the sample gas inlet, the carrier gas source and to a sample loop which is configured to contain a sample volume of the gas sample. The first sample valve injects the sample volume into the separation column and individual component gases in the sample gas separate as they move through the separation column. A detector detects a concentration of an individual component gas as a function of a sensitivity of the detector. A controller changes a response factor of the gas chromatograph by changing at least one of the sensitivity of the detector and the sample volume.

### BACKGROUND

Gas chromatograph is a technique used to analyze a mixture of chemical compounds by separating them into individual components due to their differing migration rates through a chromatographic column. This separates the compounds based on differences in boiling points, polarity, molecular size, or other factors. The separated compounds are then analyzed by a suitable detector, such as a flame photometric detector (FPD), that determines the concentration and/or presence of each compound represented in the overall sample. Knowing the concentration or presence of the individual compounds makes it possible to calculate certain physical properties such as BTU or a specific gravity using industry-standard equations.

In operation, a sample is injected into a chromatographic separation column filled with a packing material. Typically, the packing material is referred to as a “stationary phase” as it remains fixed within the column. A supply of inert carrier gas is provided to the column to force the injected sample through the stationary phase. The inert carrier gas is referred to as the “mobile phase” since it transits the column.

As the mobile phase pushes the sample through the column, various forces cause the constituents of the sample to separate. For example, heavier components move more slowly through the column relative to the lighter components. This causes the sample gases to separate into its individual component gases which, in turn, exit the column in a process called elution. The resulting individual component gases are then fed into a detector that responds to some physical trait of the eluting components.

The sensitivity of a gas chromatograph is determined by the volume of the sample loop and the gain (amplification) of the electronic sensors. Traditionally, a gas chromatograph is configured with a sample loop having a fixed volume and with fixed electronic amplification gains, such as high voltage settings for flame ionization detector (FID) and flame photometric detector (FPD), depending on the application. However, for applications with large detection ranges, multiple detectors, and even multiple gas chromatographs are required to assign one component range to one detector (or gas chromatograph) and another component range to another detector, and so on. It can be a very cumbersome to process the combined data to control or monitor a process.

### SUMMARY

A gas chromatograph for analyzing content of a gas sample includes a sample gas inlet configured to receive the gas sample and a carrier gas source which provides a carrier gas. A separation column is configured such that individual component gases in the sample gas separate as they move through the separation column. A first sample valve is coupled to the sample gas inlet, the carrier gas source and to a sample loop which is configured to contain a sample volume of the gas sample. The first sample valve injects the sample volume into the separation column and individual component gases in the sample gas separate as they move through the separation column. A detector detects a concentration of an individual component gas as a function of a sensitivity of the detector. A controller changes a response factor of the gas chromatograph by changing at least one of the sensitivity of the detector and the sample volume.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the Background.

### BRIEF DESCRIPTION OF THE DRAWINGS

FIG. 1 is a simplified diagram of a gas chromatograph.

FIG. 2 is a more detailed block diagram showing components of the gas chromatograph of FIG. 1.

FIG. 3 is a graph of detector response versus mass.

FIG. 4 shows diagrams of a 6 and 10 port analytical valve having fix sample loop volumes.

FIGS. 5A and 5B are diagrams of a 6 and 10 port analytical valve having adjustable sample loop volumes in accordance with one example embodiment.

FIG. 6 is a graph showing a relationship between supply voltage and gain for a typical photomultiplier tube used in a detector of a gas chromatograph.

FIG. 7 is a graph showing how a dynamic response factor can be used to extend the detection range of a gas chromatograph.

### DETAILED DESCRIPTION OF ILLUSTRATIVE EMBODIMENTS

Embodiments of the present disclosure are described more fully hereinafter with reference to the accompanying drawings. Elements that are identified using the same or similar reference characters refer to the same or similar elements. Some elements may not be shown in each of the figures in order to simplify the illustrations.

The various embodiments of the present disclosure may be embodied in many different forms, and should not be construed as limited to the specific embodiments set forth herein. Rather, these embodiments are provided so that this disclosure will be thorough and complete, and will fully convey the scope of the present disclosure to those skilled in the art.

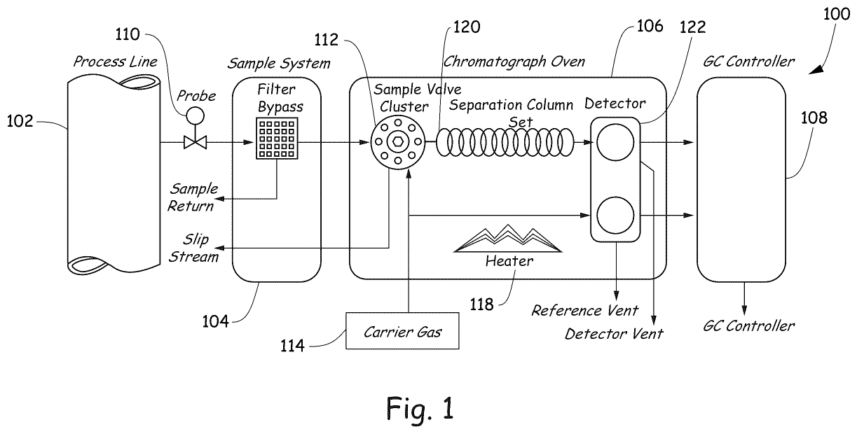

FIG. 1 is a simplified diagram of a gas chromatograph 100 in accordance with one example embodiment of the present invention. Gas chromatograph 100 couples to a process line or piping 102 carrying a process fluid. As used herein, process fluid refers to both liquid and gas phase substances, or their combination. The gas chromatograph 100 includes a sample system 104, a chromatograph oven 106 and a controller 108. The sample system 104 couples to the process line 102 through a probe 110 having a valve therein. Sample system 104 includes a filter which filters undesired components from the sample and provides a sample return. The filtered gas sample is provided to an analytical sample valve cluster 112 in the chromatograph oven 106. Sample valve 112 can comprise any number of individual or compound valves. The chromatograph oven includes a heater 118 which is used to heat components within the oven 106 including the sample valve cluster 112, separation column set 120 and detector 122. Separation column set 120 includes one or more individual separation columns. The sample valve cluster 112 includes at least one valve and is typically a complex valving device which allows valve(s) to be purged prior to analyzing the sample gas, as well as mix a carrier gas from a carrier gas source 114 with the sample gas. The analytical sample valve cluster 112 couples to a sample loop which contains a sample volume of the gas sample. The carrier gas is applied and mixed with the gas samples such that the gas sample is forced through separation column set 120. Individual component gasses in the sample gas separate as they traverse the sample valve cluster and the column set 120 and enter detector 122 at different times, thereby allowing identification of the various individual component gasses and their concentration.

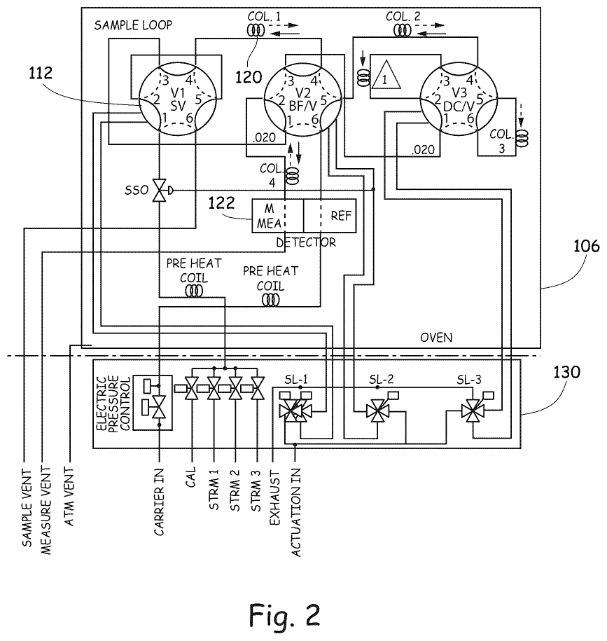

The individual component gasses are detected by detector 122. The detector 122 provides outputs to the gas chromatograph controller 108 which provides an output to an operator indicating the concentration levels of the various individual component gasses present in the sample gas. The controller 108 is also used to control operation of the gas chromatograph 100 including obtaining the sample gas, controlling the timing of the sample valve cluster 112, controlling the pressure of the carrier gas as it is applied to the sample valve cluster 112 and the separation column set 120, controlling the heater 118 among other things. FIG. 2 is a more complex diagram of oven 106 of gas chromatograph 100 shown in FIG. 1. FIG. 2 illustrates multiple separation columns and multiple sample/analytical valves used to control gas flow.

The sensitivity, or “response factor”, of the gas chromatograph 100 is a function of the sample gas volume provided by the sample loop (see FIG. 2) and the sensitivity of the detector 122. Preferably, the sensitivity of the gas chromatograph is selected to provide accurate measurements over a range of concentration of individual component gases in the gas sample. Typically, if a concentration of a component gas is outside of this range, the concentration measurements are less accurate. It is desirable for the gas chromatograph to provide accurate gas concentration measurements over a wide range of concentrations.

Traditionally, a gas chromatograph is configured with a fixed sample loop volume and a detector with a fixed sensitivity. For example, by fixing the high voltage level supplied to a flame ionization detector (FID) or a photometric detector (FPD), depending on application, the sensitivity of the detector is fixed. This results in the gas chromatograph having a fixed response factor. For applications with large detection ranges, multiple detectors, or even multiple gas chromatographs, are required to assign one range to one detector (or gas chromatograph), and another range to another detector, and so on. This requires a significant amount of extra equipment and it is cumbersome to process the combined data to control or monitor a process.

With the present invention, a gas chromatograph 100 is provided with a dynamic response factor that allows the sample loop volume and/or gain/sensitivity of the detector to be controlled.

It is typically desirable to have a gas chromatograph with the largest detection range possible to cover a wide range of gas concentrations which may be present in a gas sample. Modern gas chromatographs can be configured to cover most of the detection ranges needed. However, wider detection ranges are still desirable. For example, gas chromatographs with a photometric detector are specified with limited detection ranges, such as 5-300 PPM, 10-600 PPM, 200 PPM-1.2%, 450 PPM-2% total sulfur, for a flare compliance gas analyzer. In other words, the linear portion of output range is limited in a photometric detector, typically to one order of magnitude, and at most a range of less than two orders of magnitude is achievable. In the case of the above example, the photometric detector detection range is less than 60.

The ideal gas law is one of the theories that gas chromatograph is based on. The theory states that:

$$PV = nRT$$

$$n = \frac{PV}{RT} = \frac{m}{M}$$

$$m = \frac{PVM}{RT}$$

Where the variable are as follows:
P Pressure
V Volume
n Amount of substance
R Ideal gas constant
T Temperature
m Mass of substance
M Molar mass of substance

For mixed gases, having components i with concentration ppm:

$${m}_{i} = \frac{{PVM}_{i}}{RT} * {ppm}_{i} = {Const}_{i} * V * {ppm}_{i}$$

$${Const}_{i} = \frac{{PM}_{i}}{RT}$$

Where:
mᵢ Mass of component i of mixed gases
Mᵢ Molar mass of
ppmᵢ Concentration of component i of mixed gases

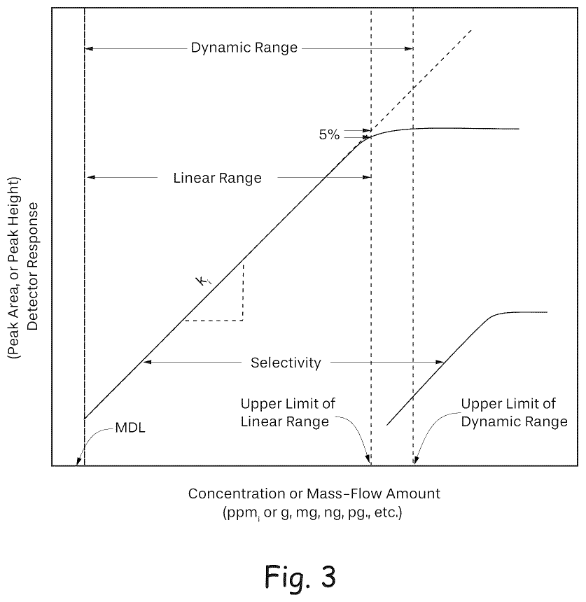

Within the linear range of the detector, the detector response is proportional to the mass of the component, as shown in FIG. 3.

$$Peak {Area}_{i} = {k}_{i} * {m}_{i} = {k}_{i} * {Const}_{i} * V * {ppm}_{i}$$

$$Peak {Area}_{i} = {C}_{i} * V * {ppm}_{i}$$

$$Where {C}_{i} = {k}_{i} * {Const}_{i}$$

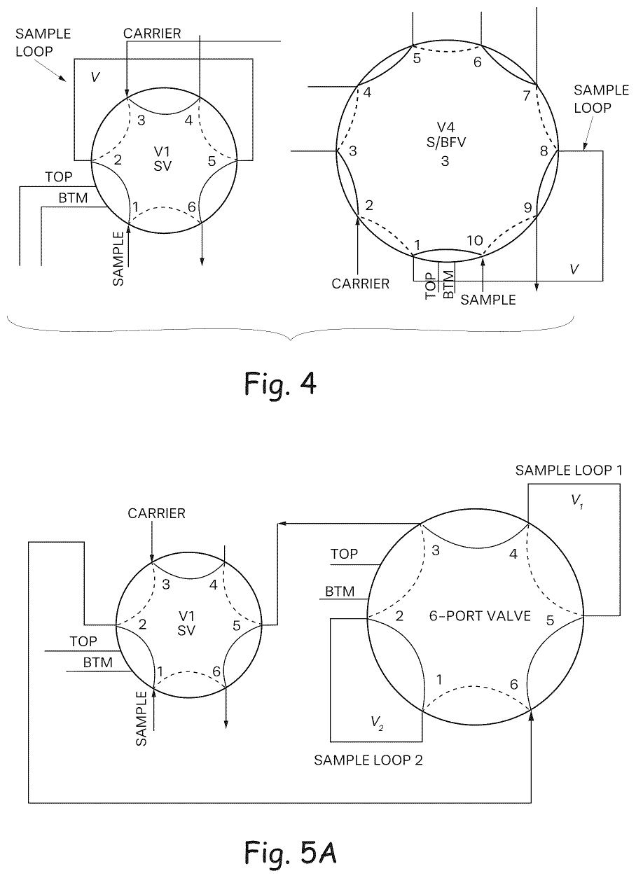

Rᵢ, the response factor of component i of mixed gases, is defined as:

$${R}_{i} = \frac{Peak {Aera}_{i}}{{ppm}_{i}} = {C}_{i} V$$

Where V is volume of sample loop. For a traditional gas chromatograph, V is determined by the size of the sample loop and is constant once a sample loop is selected and installed. Such a traditional configuration is shown in FIG. 4. As shown in FIG. 4, the sample loop extends between two valve ports and is configured to hold a volume V of the gas sample.

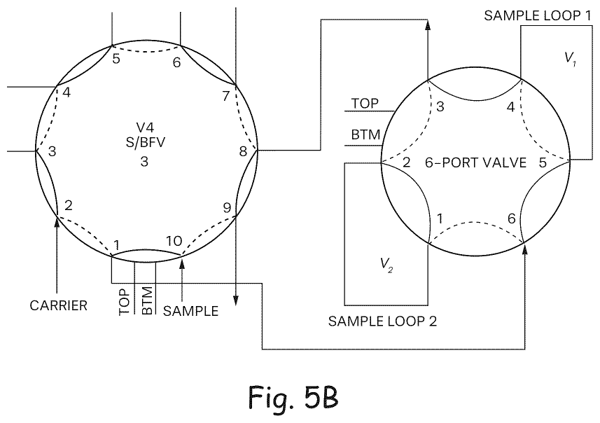

However, if a gas chromatograph includes a plurality of sample loops, and one or more sample loops are dynamically selectable, the response factor can be adjusted as desired by changing between available sample loops to thereby change the sensitivity range of the device for a particular measurement. Specifically, more than one sample loop can be provided, and a sample loop selected as desired to perform within a measurement range. FIG. 5A shows an example of 2 sample loops using a 6-port valve for use in a gas chromatograph, and FIG. 5B shows configuration with a 10-port valve. Although 2 sample loops are shown, the invention further includes the use of any number of sample loops. The sample loops can be used individually, in series, and/or in parallel to control the total sample volume as desired.

The response factor provided by each sample loop can be determined as:

$${R}_{i , 1} = Ci * V 1$$

$${R}_{i , 2} = Ci * V 2$$

Where:
R_{i,1} Response factor of component i of mixed gases for sample loop V₁.
R_{i,2} Response factor of component i of mixed gases for sample loop V₂.
Let

$${K}_{V} = \frac{{V}_{2}}{{V}_{1}}$$

$${R}_{i , 2} = {K}_{V} * {R}_{i , 1}$$

In other words, when switching to sample loop V₂ from V₁, the detector's detection range is extended by K_{V} times. The value of K_{V}, the range extension factor of the sample loop, is a constant and is measurable as:

$${K}_{V} = \frac{Peak {Area}_{2}}{Peak {Area}_{1}}$$

K_{V} can also be estimated by calculating the volumes of sample loops. For example, if sample loop 1 is a 4 inch long tube with a 0.02 inch inner diameter and sample loop 2 is a 48 inch long tube with a 0.04 inch inner diameter, the range extension is:

$${K}_{V} = \frac{{V}_{2}}{{V}_{1}} = \frac{\frac{1}{4} π {d}_{2}^{2} {L}_{2}}{\frac{1}{4} π {d}_{1}^{2} {L}_{1}} = \frac{{d}_{2}^{2} {L}_{2}}{{d}_{1}^{2} {L}_{1}} = \frac{{0.04}^{2} * 48}{{0.02}^{2} * 4} = 48$$

The actual value of K_{V} will always be less than the theoretical calculated value above due to the dead volume present in sample/analytical valves.

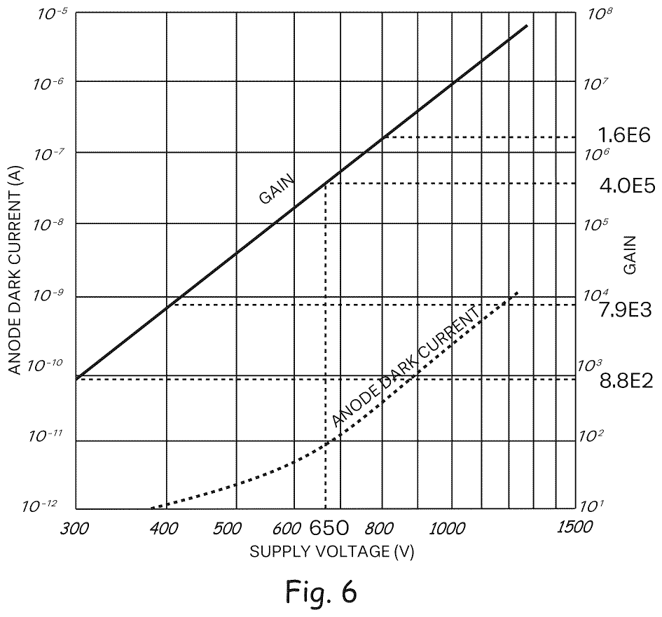

The response constant (gain) of a gas chromatograph is also a function of the sensitivity of detector 122. Various factors affect the sensitivity of the detector 122 including its construction (such as the mechanical design of the detector), the electronic amplifier used with the detector, among other factors. For example, the response constant of a transparent conducting oxide (TCO) based detector depends on the material used. The response constant of a flame photometric detector (FPD) depends on the high voltage applied to the photomultiplier tubes used in the detector. FIG. 6 shows the relationship between gain and the supply voltage for a typical photomultiplier tube of a type which is widely used in FPD detectors.

For FPD detectors using the photomultiplier tube illustrated graphically in FIG. 6, the range extension factor Kₚ can be estimated as:

$${K}_{P ( \frac{800 V}{300 V} )} = \frac{{k}_{800 V}}{{k}_{300 V}} = \sqrt{\frac{1.6 E 6}{8.6 E 2}} = 42$$

$${K}_{P ( \frac{800 V}{400 V} )} = \frac{{k}_{800 V}}{{k}_{400 V}} = \sqrt{\frac{1.6 E 6}{7.9 E 3}} = 14$$

$${K}_{P ( \frac{800 V}{650 V} )} = \frac{{k}_{800 V}}{{k}_{650 V}} = \sqrt{\frac{1.6 E 6}{4. E 5}} = 2$$

Kₚ can also be precisely measured:

$${K}_{P ( \frac{V 2}{V 1} )} = \frac{Peak {Aera}_{V 2}}{Peak {Aera}_{V 1}}$$

The total response factor for a gas chromatograph is a function of all of the individual response factors, K_{V}, K_{P}, etc. The total range extension factor K is calculated:

$$K = {K}_{V} * {K}_{P} * …$$

The linear range of detectors can be extended by K=K_{V}*K_{P}* . . . .

The detection range of TCD detectors can be extended by 48 times if 2 sample loops (K_{V}=48) are used in the above example:

$$K = {K}_{V} = 48$$

In a specific example, the detection range of an FPD detector-based gas chromatograph can be extended by 672 times if two sample loops (K_{V}=48) are used and two high voltage settings of 800V and 400V (K_{P}=14) are provided to the detector. The total range extension K is then:

$$K = {K}_{V} * {K}_{P} = 48 * 14 = 672$$

The detection range of FPD detectors can be further extended to over 1000 times easily.

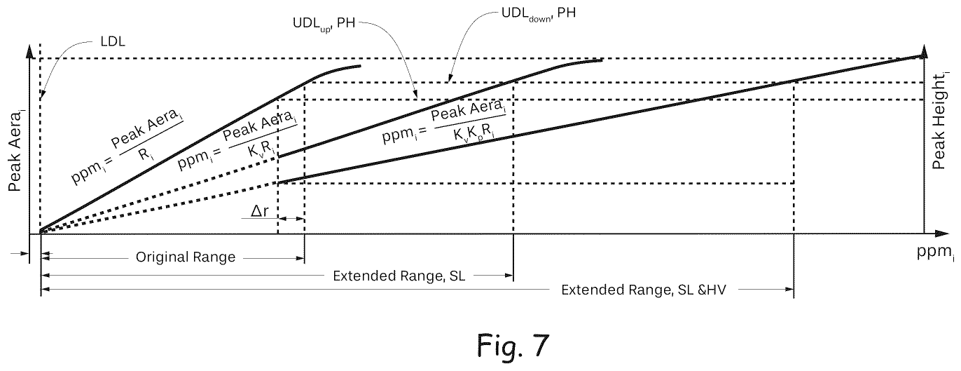

Sample loops and supply voltage of detectors can be automatically and dynamically selected by software run in controller 108. The controller 108 can control operation of valve 112, for example, of the gas chromatograph to adjust the sample loop volume as desired. Similarly, the controller 108 can control electronics associated with detector 122 to control gain and/or range as desired. This allows operation to be which transparent to an end user. FIG. 7 illustrates how dynamic response factors extend the detection range of a gas chromatograph.

A gas chromatograph is provided which has a dynamic response factor and comprises a sample volume, a detector and an intelligent control system. The gas chromatograph may further include 2 or more selectable sample loops. The detection range of the detector is determined by the gain/sensitivity, which with some detectors is proportional to supply voltage or current. In one configuration, the control system automatically selects either or both of the sample loops of and/or supply voltage and/or current to archive a desired response factor.

The above discussed range factor extension can be applied to other types of detectors which are used in gas chromatographs, such as flame ionization detectors (FID), pulsed discharge detectors (PDD), electron capture detectors (ECD), etc.

The dynamic response factors set forth herein can be used to extend detection range and/or increase the measurement accuracy of the gas chromatograph.

Although the present invention has been described with reference to preferred embodiments, workers skilled in the art will recognize that changes may be made in form and detail without departing from the spirit and scope of the invention.

What is claimed is:

1. A gas chromatograph for analyzing content of a gas sample, comprising:
a sample gas inlet configured to receive the gas sample;
a carrier gas source which provides a carrier gas;
a separation column configured such that individual component gases in the sample gas separate as they move through the separation column;
a first sample valve coupled to the sample gas inlet and the carrier gas source and to a sample loop which is configured to contain a sample volume of the gas sample, the first sample valve configured to inject the sample volume into the separation column wherein individual component gases in the sample gas separate as they move through the separation column;
a detector configured to detect a concentration of an individual component gas as a function of a sensitivity of the detector; and
a controller configured to change a response factor of the gas chromatograph by changing at least one of the sensitivity of the detector and the sample volume.

2. The gas chromatograph of claim 1 wherein the response factor is changed by changing the sample volume.

3. The gas chromatograph of claim 2 including at least two sample loops and wherein the sample volume is changed by selecting the at least one of the at least two sample loops.

4. The gas chromatograph of claim 3 wherein a single one of the at least two sample loops is selected.

5. The gas chromatograph of claim 3 wherein two of the at least two sample loops is selected.

6. The gas chromatograph of claim 1 wherein the sensitivity of the detector is changed by changing a voltage applied to the detector.

7. The gas chromatograph of claim 1 wherein the sensitivity of the detector is changed by changing a current applied to the detector.

8. The gas chromatograph of claim 1 wherein the detector comprises a flame ionization detector.

9. The gas chromatograph of claim 1 wherein the detector comprises a photometric detector.

10. The gas chromatograph of claim 1 wherein the detector includes a transparent conducting oxide based detector.

11. The gas chromatograph of claim 1 wherein the detector comprises a pulse discharge detector.

12. The gas chromatograph of claim 1 wherein the detector comprises an electron capture detector.

13. The gas chromatograph of claim 1 wherein the controller dynamically changes the response factor based upon a detected concentration of a component gas in the gas sample.

14. The gas chromatograph of claim 1 wherein the first sample valve comprises a 6-port sample valve.

15. The gas chromatograph of claim 1 wherein the first sample valve comprises a plurality of valves.

16. The gas chromatograph of claim 15 whereon the plurality of valves comprises a 6-port sample valve and a 10-port sample valve.

17. The gas chromatograph of claim 1 wherein the response factor is changed by changing a gain of the detector.

18. The gas chromatograph of claim 1 wherein the response factor is changed by changing the sample volume and the sensitivity of the detector.

19. A method of analyzing content of a gas sample with a gas chromatograph, comprising:
receiving a gas sample from a sample gas inlet;
providing a carrier gas;
providing a separation column;
providing a sample volume coupled to a first sample valve configured to receive the gas sample and the carrier gas;
injecting the sample volume of the gas sample and the carrier gas into the separation column whereby individual component gases in the sample gas separate as they move through the separation column;
detecting concentration of an individual component gas as it flows through a detector, wherein the detection is a function of a sensitivity of the detector;
dynamically adjusting a response factor of the gas chromatograph by changing at least one of the sensitivity of the detector and the sample volume.

20. The method of claim 19 wherein the response factor is changed by changing the sample volume.

21. The method of claim 19 wherein the response factor is changed by changing the sensitivity of the detector.

22. The method of claim 19 wherein the response factor is changed by changing the sample volume and the sensitivity of the detector.
